(19) United States
(12) Patent Application Publication
(10) Pub. No.: US 2008/0012733 A1
(43) Pub. Date: Jan. 17, 2008

(54) System for information, location and schedule control for passenger transport vehicle

(76) Inventor: Agustin Bermudez, Rosario (AR)

Correspondence Address: BACHMAN & LAPOINTE, P.C., 900 CHAPEL STREET, SUITE 1201, NEW HAVEN, CT, 06510, US

(21) Appl. No.: 11/825,347

(22) Filed: Jul. 6, 2007

(30) Foreign Application Priority Data
Jul. 6, 2006 (AR) P060102910

(51) Int. Cl. G08G 1/123

(52) U.S. Cl. 340/994

(57) ABSTRACT

Location of vehicles is carried out using the global positioning system in such a manner that the signals of the system are captured by a receiver placed on each of the vehicles in such a way that the same receives and processes the information related to location, direction and speed generated automatically and transmits it by the interface board to a CPU that, independently of the central operation office, determines the relative location and schedule of the carrier vehicle in order to compare them with the location and schedule planned and stored in the data base, showing the resulting time difference on the display included in the unit. The CPU, through the interface board operates at least one monitoring camera, a smart card recording reader, a ticket machine, a coin and note reader and an information board for the passengers.

### FIELD OF THE INVENTION

This invention refers to a system for information, location and schedule control for passenger transport vehicles, being its main objective to obtain a highly simple system that, applied to the vehicles of a company working with passenger transportation that enables each of the vehicle drivers to know the position of the vehicle being driven as well as the time difference in relation to the planned schedule sheet.

### PRIOR ART

In the prior art, Publication CN 1395225 is known and refers to a system and a method for the location of public service transport, information which is transmitted by the vehicles and saved onto a displayed map so that the passengers are able to know where these vehicles are located at every moment.

Publication CN 1360289 is also known, which refers to an electronic report combined with a GPS to show to the passengers the name of the next stop as well as its location.

Publication CN 1397918 refers to a method and system composed of a plurality of infrared emitter arranged along the vehicle route to be controlled which send information to a control and from there to an electronic board inside the vehicle.

Publication JP2003099893 comprises a system that provides a communication from a delayed vehicle in its route to report this to the main office that transmits a message visible in the vehicle stops.

Patent FR 2784778 presents a system that receives, from the vehicle, a report about its position in order to make a comparison related to the theoretical location and send a signal only in case some difference is recorded.

Patent JP 2002236998 refers to an information system, method and storage means of an information related to the position of a vehicle where said information is transmitted from each of the stops to a base station and then stored. This base station can transmit information to the vehicle as well as to the closer stops.

Patent JP 2001118195 refers to a location system which converts the location of a vehicle in information related to the actual location and to the estimated time of arrival to a stop. By means of the information provided from a base station through cable television, the user can have access to the information.

Patent TW391093 refers that the vehicle has a radio transmitter which sends a signal captured by a radio receiver provided in the vehicle stop. When the vehicle is near the stop, the radio transmitter sends a signal which is interpreted by the passengers who are waiting as an indicator of proximity. Passengers then press a button that sends a signal which is interpreted by the driver meaning that there are passengers ready to get on the vehicle.

Patent WO9808206 is a system that indicates to the passengers waiting for the vehicle about its status, including an estimate time of arrival. Besides, a localizer indicates the location of the different vehicles along each of their respective routes.

Patent JO 11134598 refers to a locating system that enables both to indicate the arrival time of a bus and to indicate the driver the possible problems produced on the route.

The document FR 2751112 refers to a method that uses mobile units to transmit data to a control center indicating the location of said unit, and, in each case the existing distance up to the tolerance area.

Patent JP11003495 is a locating system that reports to the users who are waiting at the bus stop.

Document JO8235497 is a locating system by means of a radio data transmission from a bus which allows passengers to organize better.

Patent U.S. Pat. No. 5,557,758 refers to a bridge carried out between two buses by means of a computer system to determine the memory location or the access to a data base. The memory has cycles in which end a transfer of data is carried out.

Patent U.S. Pat. No. 5,557,758 refers to a data input and output interface related to a circuit. A logic signal produces an response with a reference voltage provided by the driver.

Patent JP 2250199 is a bus locating system to determine the ahead or delay time of the bus based on a data series to create an aproximate valid control and display in an appropriate screen.

Document WO 0063866 refers to a method and system to provide a time estimate of a bus arrival. For that matter there are transponders/ receivers and transmitters/receivers at the bus stops and they capture and retransmit the information to each bus that is approaching.

Patent FR2694116 refers to a an usable board at the bus stops where the route is exhibited together with an illuminated sector that represents the bus location in said route and a mising time estimate until the arrival of the next vehicle.

Patent FR2784777 refers to a device that enables to compare in real time the location data received from a GPS with those stored, transmitting an automatic message in case the GPS data and the memory exceed a predetermined value. An information receiving and processing central unit is included.

Publication JP2000132796 refers to a system that provides an antenna and a GPS receiver to estimate the waiting time until the arrival to a stop, as well as the service condition.

Publication JP2004102411 refers to a high precision vehicle locating system.

Document DE19839525 is a system that combines public and private vehicles.

Document DE19839525 refers to a positioning system for public transport vehicles by using synchronization points that capture the passing of vehicles.

Document DE 19803254 enables a dynamic location and a signal system to be used in vehicles, such as for example buses.

Document DE 10061322 refers to an information supply service for public transportation which includes the transmission of the location to a control central point and to users' mobile phones.

Document DE 10033830 is an information system for public transportation which uses a GPS and reports to the users the updated location.

Patent U.S. Pat. No. 4,350,969 indicates that the vehicles to be controlled are provided with a radio transmitter set to different signal frequency. One part of this is vehicle identification; the other part can automatically get information from the odometer to set up the location. The radio transmitter enables to get audio produced in the vehicle and the passengers can be provided with adjusted receptors to capture the location signal of a certain vehicle.

Finally, patent DE 4326237 is a method to locate vehicles by means of a GPS localizer and send said information to the users and to a con.

### SUMMARY OF THE INVENTION

A system for information, location, and schedule control for passenger transport vehicles comprises means for locating the vehicles by means of a global positioning system and a received placed on each of the vehicles for capturing system signals. Each received obtains and processes information related to location, direction, and speed and sends information through an interface board to a CPU which, independently of an operation control office, determines a position and time scheduled and stored in a database to show a result on a display. The CPU, by means of the interface board, interacts with at least one monitoring camera, a smart card recording reader, a ticket machine, a coin and notes reader, and an information board.

### BRIEF DESCRIPTION OF THE DRAWINGS

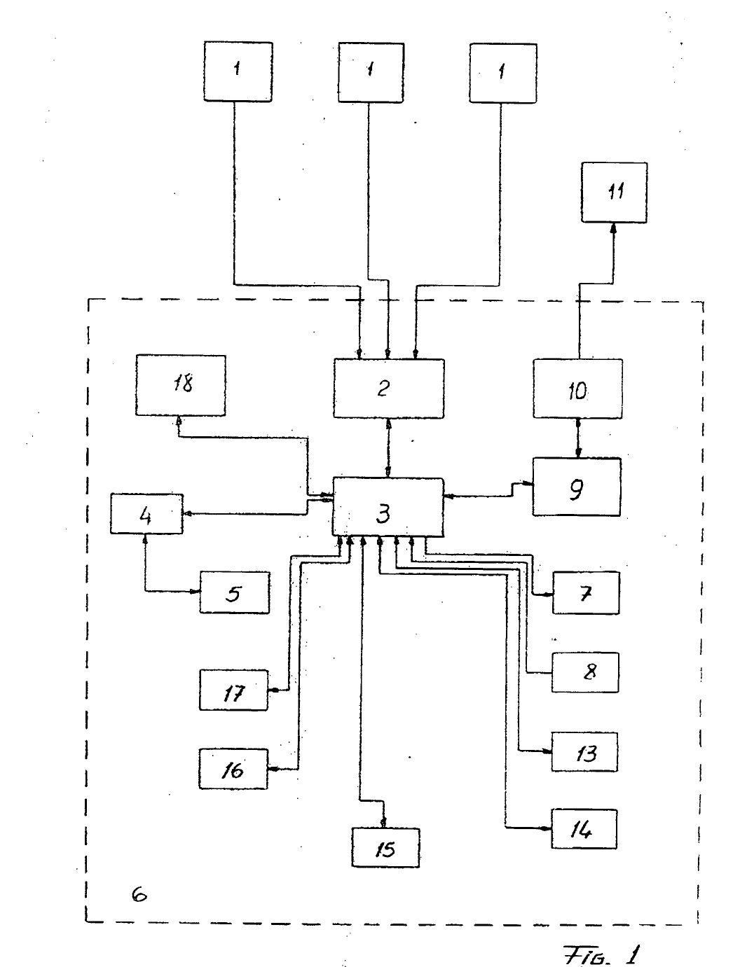

In the drawings attached to this description, the different components that make up the system which is being claimed have been outlined in FIG. 1.

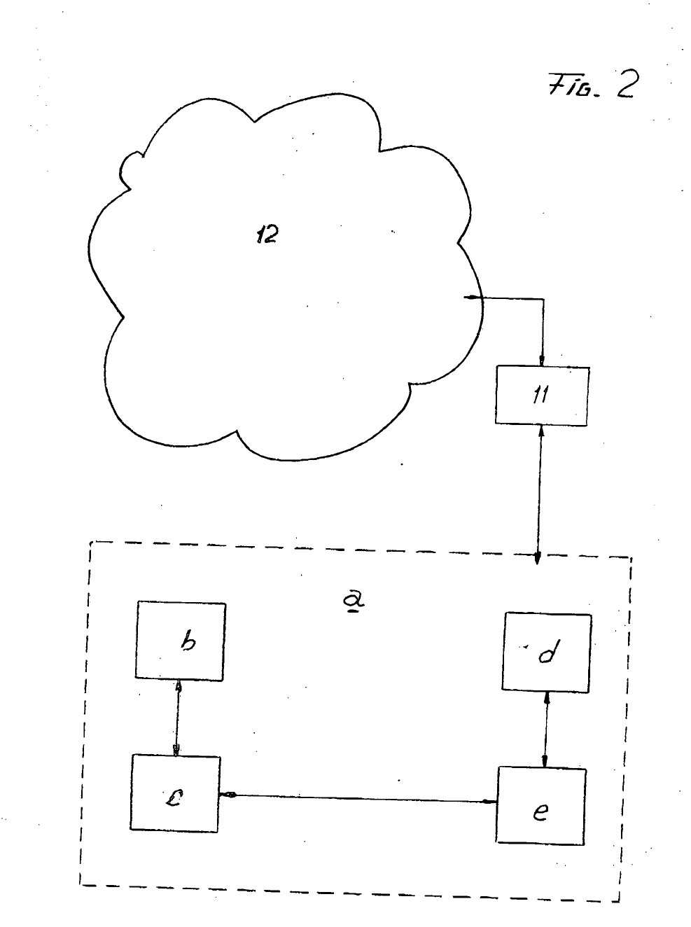

In FIG. 2, a communication outline with the control office center has been depicted.

### DETAILED DESCRIPTION OF THE PREFERRED EMBODIMENT(S)

In the attached figures, references indicate sets or its component parts and each of them is used exclusively to design said sets or component parts.

For this purpose reference numbers have been used in the following manner: reference number-1-to indicate a satellite; reference number-2-to indicate a GPS receiver; reference number-3-to indicate an interface board; reference number-4-to indicate a CPU; reference unit-5-to indicate a data base; reference number-6-to indicate a unit or vehicle; reference number-7-a display or screen; reference number-8-to indicate a keyboard; reference number-9-to indicate a communication board; reference number-10-to indicate a cell phone, reference-11-to indicate a communication supplier: reference number-12-to indicate the internet; reference number-13-to indicate a monitoring camera; reference number-14-to indicate a smart card reading recorder; reference number-15-to indicate a ticket machine; reference number-16-to indicate a coin and note reader; reference number-17-to indicate an information board and the reference number-18-to indicate a feed and stabilization board.

Besides several letters have been used in such a way that-a-indicates a central operation office;-b-indicates a firewall server; letter-c-indicates a data base server and letter-e-indicates an application server.

According to the attached figures, this system comprises a GPS localizer also known as a global positioning system, an interface electronic board; a central processing unit or CPU; a communication board, a cell phone, a keyboard, a display, a feed and stabilizing board, a monitoring camera, a smart card recorder, a ticket printer machine, a coin and note reader, an information board and a special software that includes at least, the route of the vehicles and their respective planned schedules.

This system enables to know the time difference, measured in minutes and seconds, that results from comparing the position and schedules planned for the vehicle, with the real ones. This information will definitely enable the driver to take the necessary measures to revert the situation.

It is also the purpose of this documentation that a central office gets the data from all the units being administered to make up a map, indicating the routes that are being followed and the existing differences between the fixed schedules and their observance, thus providing a global idea of the passing frequency of units through the stops.

It is known that all companies of local and intercity passenger transportation are compelled to make up schedule planning so that the vehicles run with prefixed intervals among them. This is partly imposed by the agency in charge of controlling public transportation since in this way passengers find a certain service offer and it partly results from the transport companies urge since in this way they optimize the use of vehicles and they attract greater amount of passenger, thus increasing the frequency in peak hours.

At present drivers use sheets that tell them about the departure and arrival time schedules to terminal station and crossing times in reference points along the route, in order to keep a pre-fixed frequency.

This is not absolute and therefore it implies that a vehicle, can go ahead or be delayed for several reasons with respect to the planned schedule, thus provoking a situation in which two vehicles can be traveling together or, on the contrary, too separated one from the other.

In order to avoid this, it is usual that the driver makes an estimate in an intuitive manner. This development thereby enables to obtain an adequate tool to carry out the control of the vehicle relative location and also enables the driver to be able to have precise information to regulate speed.

This invention offers then two advantages; on one hand passengers do not experience passing frequency variations of the vehicles through the stops, and on the other hand the use of the units is optimized.

This optimization of the vehicles use grants a greater loading capacity and at the same time the overloading of some vehicles during peak hours is avoided.

Other indirect benefits that are achieved with the passing regularity and a rational use of the vehicles are the reduction of accidents in general, fuel consumption reduction, optimization in schedule layouts, simplification of driving tasks for drivers, and easy administrative control for the inspectors.

Once the different components of the invention version have been established and developed to explain their nature, the description is next complemented with the functioning and operating relationship of its parts and the result they provide.

The satellites-1-that integrate the global positioning system also known by its acronym in English GPS transmit the corresponding signals that let a receiver-2-of said signals receive them and process the information related to location, direction and speed.

Said information is received in format NMEA 0183, by an interface board-3-from where it is then transmitted to a CPU-4-.

It is in said CPU (4) where the received information from the interface board (3) is processed and compared with the internal data base-5-in order to estimate the location of a certain unit-6-.

Such actual location of a vehicle-6-is compared against a theoretical model of the route that was previously scheduled and transmitted by the operation central office (a), which enables to estimate the minutes ahead or delayed that each unit has (6).

The difference data obtained in such manner are shown to the vehicle driver (6) by means of a display-7-who therefore modifies the speed, to adjust his present position to the theoretical position in order to fulfill, or at least get near to, the previously planned schedule.

In this way the driver knows the actual time of difference that exists between the theoretical schedule that he should be fulfilling and the actual schedule which is the result of the different traffic events.

This information generated in the vehicle (6) is self sufficient and thus independent from the operation central office (a).

For this reason, even in the case of connection interruption between the operation central office (a) and the vehicle (6) the driver will be able to go on interacting with the CPU (4) and receiving the schedule difference data already mentioned.

Said CPU enables the data entry in a hand-operated mode by means of a supplied keyboard-8-and it also has a display (7) that enables the monitoring of the information created as a consequence of the data processing.

Considering that the driver must keep his whole attention in the vehicle driving (6), the related data to the position and to the relative delay or ahead time of the same are created in an automatic way by the CPU (4) and transmitted, to the operation central office (a) where they are shown onto a digital map.

Although the vehicle driver (6) can modify his traveling speed in order to adjust to the theoretical model, the operation central office (a) will be able to prepare and send an alternative plan to compensate the difference.

By means of a keyboard (8) and a display (7) located on the vehicle (6), the unit driver will be able to send and receive elaborate messages and with several contents to the operation central office (a). Both the keyboard (8) and the display (7) included in the unit (6) are preferably vandal resistant.

In order to carry out said data communication, the CPU 4 establishes a connection with the office (a) by means of the Internet service (12) provided by the communication supplier (11). This connection is done by means of the interface board (3), a communication board-9-and the cell phone-10-.

In a manner of preferable implementation, this system includes a wireless communication device (10) that enables to keep an exchange of information orally between the unit (6) and the operation central office (a).

In relation to this, to keep a fluent communication with the operation central office (a) offers the possibility to communicate certain type of information in real time. This takes to, at the same time, the dispatcher or person in charge of the line have the possibility to modify schedules and routes to adequate to said circumstances, also in real time.

In the operation central office (a) there is a firewall-b-, a communication server-c-a data base server-d-and an application server-e-.

In turn the CPU (4) by means of the interface board (3), handles several peripherals on board of the unit (6) such as monitoring camera-13-, smart card reading recorder-14-ticket machines-15-, a coin and note reader-16-and an information board-17-for the passengers.

In a preferred manner of implementation, said information board-17-is LED based type.

The system is completed with a feed and stabilization board-18.

According to what was previously exposed, the system that is being revealed has elements included in the unit (6) which enable to solve the delay and ahead time of the same with respect to the planned schedule, in a totally independent manner from the interaction with the operation central office (a) and to provide the driver with the resulting information in an automatic and continuous manner.

The elements included in each unit (6) respect a module architecture and are operated from the CPU (4) with which the invention versatility is enarged.

In this way the constructive possibilities that help to carry out the invention and the way in which the same works has been depicted, comprising also its specific application. Documentation is complemented with the synthesis of the invention contained in the claims that are added hereinafter.

1. System for information, location and schedule control for passenger transport vehicles of comprising means for locating said vehicles by means of a global positioning system and a receiver placed on each of the vehicles for capturing system signals, each said receiver obtaining and processing information related to location, direction, and speed and sending said information through an interface board to a CPU which, independently of an operation central office, determines a position and time scheduled and stored in a data base to show a result on a display, and said CPU, by means of the interface board, interacting with at least with one monitoring camera, a smart card recording reader, a ticket machine, a coin and notes reader, and an information board.

2. System, according to claim 1, wherein the data base has, at least, routes and schedules planned for each of the vehicles.

3. System, according to claim 1, wherein all operations are carried out in an autonomous manner and independent from the operation central office and enabling an interaction between a vehicle driver and the CPU in a continuous mode.

4. System, according to claim 1, wherein an exchange of information between each vehicle and the operation central office is automatic and is complemented with information generated for specific cases.

5. System, according to claim 1, wherein the CPU has a keyboard for data entry and at least one display for an observation of messages resulting from data processing.

6. System, according to claim 1, wherein a keyboard and a display included in each vehicle are vandal resistant.

7. System, according to claim 1, wherein the CPU is linked, through the interface board and a communication board with a mobile phone, and through the Internet with a communication server of the central operation office, and said mobile phone uses services of a supplier of mobile services.
